(19) United States
(12) Patent Application Publication
(10) Pub. No.: US 2018/0240334 A1
(43) Pub. Date: Aug. 23, 2018

(54) Code Activation Device

(71) Applicant: Miezo Inc., Taipei City (TW)

(72) Inventors: Yuan-Ping Liu, New Taipei City (TW); Chao-Ting Wu, New Taipei City (TW); Wei-Ren Lai, New Taipei City (TW); Kai-Wen Cheng, Taipei City (TW); Chiao-Yu Hsiao, Tainan City (TW); Wei-Hsun Wang, New Taipei City (TW)

(21) Appl. No.: 15/689,669

(22) Filed: Aug. 29, 2017

(30) Foreign Application Priority Data
Feb. 17, 2017 (TW) 106202324

(51) Int. Cl. G08C 25/00; G08C 17/02

(52) U.S. Cl. CPC G08C 25/00; G08C 2201/00; G08C 17/02

(57) ABSTRACT

The present disclosure illustrates a code activation device used to transmit an activation signal to a back-end device, so as to activate the back-end device. The code activation device comprises a sensing module and a processing module. The sensing module comprises a sensor unit, and the sensor unit generates sensing signals according to a preset action of a trigger object. The processing module connected to the sensing module receives the sensing signals, generates a sensing beat according to interval periods between the sensing signals, and determines whether the sensing beat matches a preset beat, wherein the processing module generates the activation signal when the sensing beat matches the preset beat.

### CROSS-REFERENCE TO RELATED APPLICATION

This application claims priority from Taiwan Patent Application No. 106202324, filed on Feb. 17, 2017, in the Taiwan Intellectual Property Office, the content of which is hereby incorporated by reference in its entirety for all purposes.

### BACKGROUND OF THE INVENTION

### 1. Field of the Invention

The present disclosure relates to an activation device, and in particular, to a code activation device which determines a sensing beat and/or a sensing order according to sensing signals and generates an activation signal to a back-end device according to the sensing beat and/or the sensing order, so as to activate the back-end device.

### 2. Description of the Related Art

Generally, to activate some device to operate, or to turn on some device, the user should turn on the switch, and then, the device starts to operate or is turned on.

However, the turned-on manner of the common switch is to turn on by a simple action, and thus it usually results the switch is turned accidentally.

Accordingly, the technical problem of turning on the switch is an issue which the person with ordinary skill in the art intends to discuss and solve.

### SUMMARY OF THE INVENTION

In view of the above-mentioned problems, it is an object of the present disclosure to provide a code activation device.

In view of the above-mentioned objects, it is an object of the present disclosure to provide a code activation device.

In view of at least one object of the present disclosure, a code activation device used to transmit an activation signal to a back-end device is provided, so as to activate the back-end device. The code activation device comprises a sensing module and a processing module. The sensing module comprises a sensor unit, and the sensor unit generates sensing signals according to a preset action of a trigger object. The processing module connected to the sensing module receives the sensing signals, generates a sensing beat according to interval periods between the sensing signals, and determines whether the sensing beat matches a preset beat, wherein the processing module generates the activation signal when the sensing beat matches the preset beat.

Preferably, the sensor unit is an infrared ray sensor unit.

Preferably, the sensor unit is a piezoelectric sensor unit.

Preferably, the sensor unit is a touch sensor unit or a hit sensor unit.

Preferably, the processing module comprises a transmitting unit for receiving the sensing signals and transmitting the activation signal to the back-end device.

Preferably, the processing module comprises a storage unit for storing the preset beat.

In view of at least one object of the present disclosure, a code activation device used to transmit an activation signal to a back-end device is provided, so as to activate the back-end device. The code activation device comprises a sensing module and a processing module. The sensing module comprises sensor units, wherein the sensor units generate sensing signals according to a preset action of a trigger object. The processing module connected to the sensing module receives the sensing signals, wherein each of the sensing signals corresponds to one of the sensor units, the processing module acquires a sensing order according to an order which the sensing signals are generated by the sensor units, and determines whether the sensing order matches a preset order, wherein the processing module generates the activation signal when the sensing order matches the preset order processing module.

Preferably, the processing module comprises a storage unit for storing the preset order.

In view of at least one object of the present disclosure, a code activation device used to transmit an activation signal to a back-end device is provided, so as to activate the back-end device. The code activation device comprises a sensing module and a processing module. The sensing module comprises sensor units, wherein the sensor unit generates sensing signals according to a preset action of a trigger object. The processing module connected to the sensing module receives the sensing signals, wherein each of the sensing signals corresponds to one of the sensor units, the processing module acquires a sensing order according to an order which the sensing signals are generated by the sensor units, generates a sensing beat according to interval periods between the sensing signals, and determines whether the sensing order and the sensing beat respectively match a preset order and a preset beat, wherein the processing module generates the activation signal when the sensing order and the sensing beat respectively match the preset order and the preset beat.

In view of at least one object of the present disclosure, a code activation device used to transmit an activation signal to a back-end device is provided, so as to activate the back-end device. The code activation device comprises a sensing module and a processing module. The sensing module comprises sensor units, and the sensor units generate sensing signal sets according to a preset action of a trigger object, wherein the sensing signal set comprises sensing signals, and the time periods of the sensing signals included in the previously generated sensing signal set are earlier than those of the sensing signals included in the later generated sensing signal set. The processing module connected to the sensing module receives the sensing signal sets including the sensing signals, wherein each of the sensing signal sets corresponds to one of the sensor units, the processing module acquires a sensing order according to an order which the sensing signal sets are generated by the sensor units, generates a sensing beat according to interval periods between the sensing signals included in each of the sensing signal sets, and determines whether the sensing order and the sensing beat respectively match a preset order and a preset beat, wherein the processing module generates the activation signal when the sensing order and the sensing beat respectively match the preset order and the preset beat.

Accordingly, the code activation device in the present disclosure can determine a sensing beat and/or a sensing order according to sensing signals and generates an activation signal to a back-end device according to whether the sensing beat and/or the sensing order matches a preset condition, so as to activate the back-end device.

### BRIEF DESCRIPTION OF THE DRAWINGS

The foregoing and other features and advantages of the present disclosure will become more apparent from the following detailed description of exemplary embodiments thereof with reference to the accompanying drawings in which:

FIG. 1 is a block diagram of a code activation device according to one exemplary embodiment of the present disclosure; and

FIG. 2 is a block diagram of a code activation device according to another one exemplary embodiment of the present disclosure.

### DESCRIPTION OF THE EXEMPLARY EMBODIMENTS

While embodiments are described with reference to the accompanying drawings, it is to be understood that various changes and modifications can be made in the described technology without departing from the spirit and scope thereof. Further, it should be understood that the described technology is not limited to the specific embodiments thereof, and various changes, equivalences and substitutions can be made without departing from the scope and spirit of the described technology.

As used herein, the term “and/or” includes any or all combinations of one or more related items. When the term “at least one of” is used to prefix an element list, the entire inventory element is associated rather than the individual elements in the list.

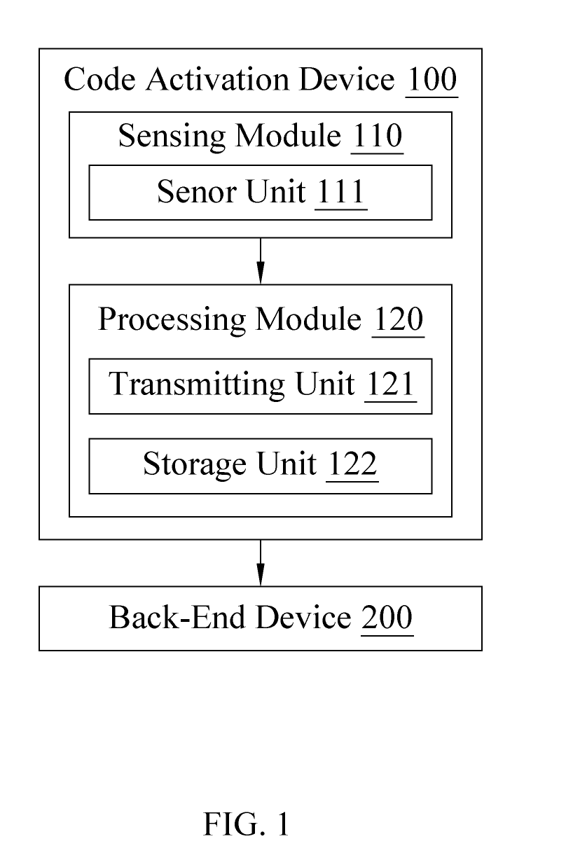

Referring to FIG. 1, FIG. 1 is a block diagram of a code activation device according to one exemplary embodiment of the present disclosure. In FIG. 1, the code activation device 100 is used to transmit an activation signal to a back-end device 200, so as to activate the back-end device 200. The code activation device 100 comprises a sensing module 110 and a processing module 120.

Specifically, the sensing module 110 comprises a sensor unit 111, and the sensor unit 111 generates sensing signals according to a preset action of a trigger object. The processing module 120 is connected to the sensing module 110 through a wired or wireless manner, and the present disclosure is not limited thereto. The processing module 120 receives the sensing signals generated by the sensor unit 111, and each two sequential sensing signals have one interval period. Thus, according to the interval periods of the sensing signals, the processing module 120 can determine a sensing beat which the sensing signals are generated in a generation procedure. Then, the processing module 120 can determines whether the sensing beat matches a preset beat, and generates the activation signal to the corresponding back-end device 200 when the sensing beat matches a preset beat, such that the corresponding back-end device 200 is activated.

Furthermore, in an actual application, the preset beat is assumed that the interval period between the first and second sensing signals is one second, the interval period between the second and third sensing signals is two seconds, and the interval period between the third and fourth sensing signals is one second. Thus, when the user wants the code activation device to generate the activation signal, he or she should firstly trigger the sensor unit 111 to generate the first sensing signal, and then trigger the sensor unit 111 to generate the second sensing signal after one second is elapsed. Next, after another two seconds are elapsed, he or she should trigger the sensor unit 111 to generate the third sensing signal. Finally, after another one second is elapsed, he or she should trigger the sensor unit 111 to generate the fourth sensing signal. Therefore, the processing module 120 generates the sensing beat according to the interval periods of each two sequential sensing signals. When the sensing beat matches the preset beat, the processing module 120 generates the activation signal and transmits the activation signal to the back-end device 200. It is noted that the above exemplary example is used describe the concept of the present disclosure, and the present disclosure is not limited thereto.

The back-end device 200 can be connected to the code activation device 100 through a wired or wireless manner, and the back-end device 200 can be a device with the variable structure, such that the back-end device 200 varies its structure according to the activation signal. Alternatively, the back-end device 200 can be the electronic device and activate a corresponding function according to the activation signal. It is noted that the above exemplary example is used describe the concept of the present disclosure, and the present disclosure is not limited thereto.

The sensor unit 111 can be an infrared ray sensor unit, and the infrared ray sensor unit can sense the preset action of the trigger object, such as the trigger object approaches the infrared ray sensor unit or wave his or her hand. In another one implementation, the sensor unit 111 can be the piezoelectric sensor unit, and the piezoelectric sensor unit senses the hit of the trigger object. In another one implementation, the sensor unit 111 can be the sensor unit 111 can the touch sensor unit, and the touch sensor unit senses the touch action of the trigger object. In another one implementation, the sensor unit 111 can be the hit sensor unit which senses sound, vibration, or corresponding member action generated by the beat. It is noted that the above exemplary example is used describe the concept of the present disclosure, and the present disclosure is not limited thereto.

Specifically, the processing module 120 comprises a transmitting unit 121, and the transmitting unit 121 receives the sensing signals generated by the sensor unit 111, and transmits the activation signal to the back-end device 200 when the processing module 120 generates the activation signal.

In another one aspect, the processing module 120 further comprises a storage unit 122 which is used to store the preset beat. The preset beat can be built and set in the storage unit 122, or alternatively, the preset beat is set by a remote device, transmitted to the processing module 120, and stored in the storage unit 122, thus making the preset beat can be adjusted according to the requirements or other factors.

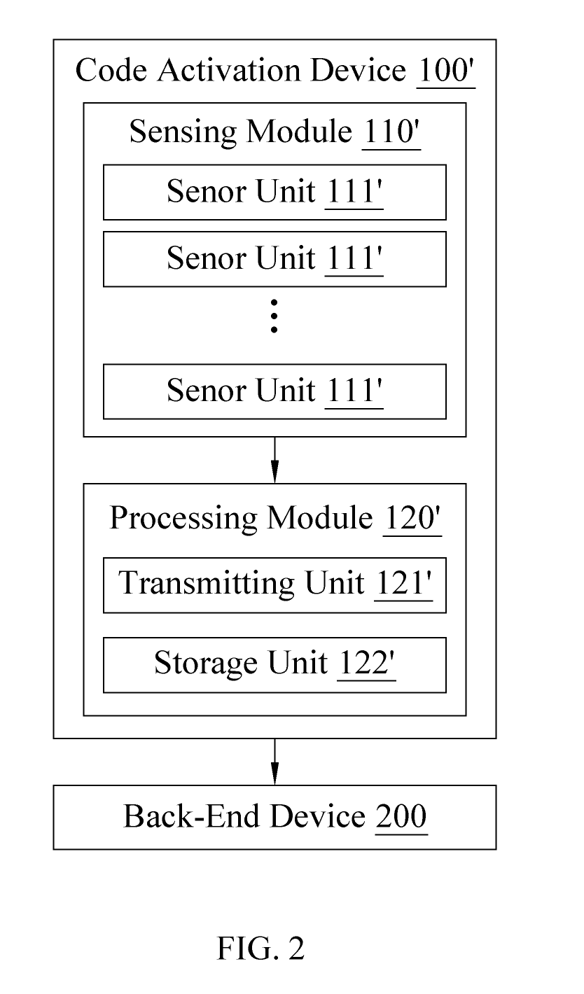

Referring to FIG. 2, FIG. 2 is a block diagram of a code activation device according to another one exemplary embodiment of the present disclosure. The code activation device 100′ is used to transmit the activation signal to the back-end device 200′, so as to activate the back-end device 200′. The code activation device 100′ comprises a sensing module 110′ and a processing module 120′. The sensing module 110′ comprises sensor units 111′, and the sensor units 111′ generate sensing signals according the preset action of the trigger object. The processing module 120′ connected to the sensing module 110′ receives the sensing signals, and each of the sensing signals corresponds to one of the sensor units 111′. The processing module 120′ generates a sensing order according to an order which the sensor units 111′ generate the sensing signals, and then determines whether the sensing order matches the preset order, wherein the processing module 120′ generates the activation signal when the sensing order matches the preset order.

The differences between the code activation devices 100′ and 100 are that the sensing module 110 has merely one sensor unit 111 while the sensing module 110′ multiple sensor units 111′, and according to an order which the sensing signals are generated by the sensor units 111′, the processing module 120′ can determine the sensing order, such that the activation signal can be generated by determining whether the sensing order matches the preset order.

In the actual application, it is assumed that the sensing module 110′ comprises a first sensor unit and a second sensor unit, and the preset order can be the first sensor unit—the second sensor unit—the first sensor unit (i.e. the first sensor unit firstly generates a first sensing signal, then the second sensor unit firstly generates a second sensing signal, and finally the first sensor unit generates a third sensing signal). When the user wants the code activation device to generate the activation signal, he or she should trigger the first sensor unit to sense, then trigger the second sensor unit to sense after the first sensor unit has been sensed, and finally trigger the first sensor unit to sense again after the second sensor unit has been sensed. According to the above sensing procedure, the sensing module 110′ generates three sensing signals, and the processing module 120′ receives the three sensing signals to determine the sensing order is the first sensor unit—the second sensor unit—the first sensor unit. The processing module further determines whether the sensing order matches the preset order, and generates the activation signal when that the sensing order matches the preset order has been determined. It is noted that the above exemplary example is used describe the concept of the present disclosure, and the present disclosure is not limited thereto.

Specifically, the processing module 120′ further comprises a transmitting unit 121′ and a storage unit 122′. The transmitting unit 121′ receives the sensing signals and transmits the activation signal, and the storage unit 122′ stores the preset order. The preset order can be built and set in the storage unit 122′, or alternatively, the preset order is set by a remote device, transmitted to the processing module 120′, and stored in the storage unit 122′, thus making the preset order can be adjusted according to the requirements or other factors.

In another one exemplary embodiment, a code activation device is provided, and the code activation device is also used to transmit the activation signal to the back-end device, so as to activate the back-end device. The code activation device comprises a sensing module and a processing module. The sensing module comprises sensor units, and the sensor units generate sensing signals according to a preset action of a trigger object. The processing module connected to the sensing module receives the sensing signals, and each of the sensing signals corresponds to one of the sensor units. The processing module acquires a sensing order according to an order which the sensing signals are generated by the sensor units, generates a sensing beat according to interval periods between the sensing signals, and determines whether the sensing order and the sensing beat respectively match a preset order and a preset beat, wherein the processing module generates the activation signal when the sensing order and the sensing beat respectively match the preset order and the preset beat.

Specifically, in an actual application, it is assumed that the sensing module comprises a first sensor unit and a second sensor unit, the preset order can be the first sensor unit—the second sensor unit—the first sensor unit (i.e. the first sensor unit firstly generates a first sensing signal, then the second sensor unit firstly generates a second sensing signal, and finally the first sensor unit generates a third sensing signal), and the preset beat is that the interval period between the first and second sensing signals is one second and the interval period between the second and third sensing signals is two seconds. Thus, when the user wants the code activation device to generate the activation signal, he or she should firstly trigger the first sensor unit to sense, then trigger the second sensor unit to sense after the first sensor unit generates the first sensing signal and one second is elapsed, and finally trigger the third sensor unit to sense after the second sensor unit generates the second sensing signal and another two seconds are elapsed. According to the above sensing procedure, the sensing module generates three sensing signals, and the processing module receives the three sensing signals to determine the sensing order is the first sensor unit—the second sensor unit—the first sensor unit, and further determines the sensing beat is that the interval period between the first and second sensing signals is one second and the interval period between the second and third sensing signals is two seconds. The processing module further determines whether the sensing order and sensing beat match the preset order and preset beat, and generates the activation signal when that the sensing order and sensing beat match the preset order and preset beat has been determined. It is noted that the above exemplary example is used describe the concept of the present disclosure, and the present disclosure is not limited thereto.

In another one exemplary embodiment, a code activation device is provided, and the code activation device is also used to transmit the activation signal to the back-end device, so as to activate the back-end device. The code activation device comprises a sensing module and a processing module. The sensing module comprises sensor units, and the sensor units generate sensing signal sets according to a preset action of a trigger object, wherein the sensing signal set comprises sensing signals, and the time periods of the sensing signals included in the previously generated sensing signal set are earlier than those of the sensing signals included in the later generated sensing signal set. The processing module connected to the sensing module receives the sensing signal sets including the sensing signals, wherein each of the sensing signal sets corresponds to one of the sensor units, the processing module acquires a sensing order according to an order which the sensing signal sets are generated by the sensor units, generates a sensing beat according to interval periods between the sensing signals included in each of the sensing signal sets, and determines whether the sensing order and the sensing beat respectively match a preset order and a preset beat, wherein the processing module generates the activation signal when the sensing order and the sensing beat respectively match the preset order and the preset beat.

Specifically, in an actual application, it is assumed that the sensing module comprises a first sensor unit and a second sensor unit, the preset order can be the first sensor unit—the second sensor unit (i.e. the first sensor unit firstly generates a first sensing signal set, and then the second sensor unit generates a second sensing signal set), and the preset beat is that the interval period between the first and second sensing signals of the first sensing signal set associated with the first sensor unit is one second, the interval period between the second and third sensing signals of the first sensing signal set associated with the first sensor unit is two seconds, the interval period between the first and second sensing signals of the second sensing signal set associated with the second sensor unit is two seconds, and the interval period between the second and third sensing signals of the second sensing signal set associated with the second sensor unit is one second. Thus, when the user wants the code activation device to generate the activation signal, he or she should firstly trigger the first sensor unit to sense, then trigger the first sensor unit to sense to generate the second sensing signal after the first sensor unit generates the first sensing signal and one second is elapsed, and then trigger the first sensor unit to sense to generate the third sensing signal after the first sensor unit generates the second sensing signal and another two seconds are elapsed. At meanwhile, the first sensing signal set of the first sensor unit has been generated. Next, the user should trigger the second sensor unit to sense, then trigger the second sensor unit to sense to generate the second sensing signal after the second sensor unit generates the first sensing signal and two seconds are elapsed, and then trigger the second sensor unit to sense to generate the third sensing signal after the second sensor unit generates the second sensing signal and another one second is elapsed. At meanwhile, the second sensing signal set of the second sensor unit has been generated. According to the above sensing procedure, the generated time period of the first sensing signal set is earlier than that of the second sensing signal set. The first sensing signal set has three sensing signals, the second sensing signal set has another three sensing signals, and the sensing module generates six sensing signals. The processing module receives the six sensing signals to determine the sensing order is the first sensor unit—the second sensor unit, and further determines the sensing beat is that the interval period between the first and second sensing signals of the first sensing signal set associated with the first sensor unit is one second, the interval period between the second and third sensing signals of the first sensing signal set associated with the first sensor unit is two seconds, the interval period between the first and second sensing signals of the second sensing signal set associated with the second sensor unit is two seconds, the interval period between the second and third sensing signals of the second sensing signal set associated with the second sensor unit is one second. The processing module further determines whether the sensing order and sensing beat match the preset order and preset beat, and generates the activation signal when that the sensing order and sensing beat match the preset order and preset beat has been determined. It is noted that the above exemplary example is used describe the concept of the present disclosure, and the present disclosure is not limited thereto.

Accordingly, the code activation device in the present disclosure can determine a sensing beat and/or a sensing order according to sensing signals and generates an activation signal to a back-end device according to whether the sensing beat and/or the sensing order matches a preset condition, so as to activate the back-end device.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A code activation device, used to transmit an activation signal to a back-end device, so as to activate the back-end device, wherein the code activation device comprises:
a sensing module, comprising a sensor unit, the sensor unit generates sensing signals according to a preset action of a trigger object; and
a processing module, connected to the sensing module, receiving the sensing signals, generating a sensing beat according to interval periods between the sensing signals, and determining whether the sensing beat matches a preset beat, wherein the processing module generates the activation signal when the sensing beat matches the preset beat.

2. The code activation device according to claim 1, wherein the sensor unit is an infrared ray sensor unit.

3. The code activation device according to claim 1, wherein the sensor unit is a piezoelectric sensor unit.

4. The code activation device according to claim 1, wherein the sensor unit is a touch sensor unit or a beat sensor unit.

5. The code activation device according to claim 1, wherein the processing module comprises a transmitting unit for receiving the sensing signals and transmitting the activation signal to the back-end device.

6. The code activation device according to claim 1, wherein the processing module comprises a storage unit for storing the preset beat.

7. A code activation device, used to transmit an activation signal to a back-end device, so as to activate the back-end device, wherein the code activation device comprises:
a sensing module, comprising sensor units, wherein the sensor units generate sensing signals according to a preset action of a trigger object; and
a processing module, connected to the sensing module, receiving the sensing signals, wherein each of the sensing signals corresponds to one of the sensor units, the processing module acquires a sensing order according to an order which the sensing signals are generated by the sensor units, and determines whether the sensing order matches a preset order, wherein the processing module generates the activation signal when the sensing order matches the preset order.

8. The code activation device according to claim 7, wherein the sensor unit is an infrared ray sensor unit.

9. The code activation device according to claim 7, wherein the sensor unit is a piezoelectric sensor unit.

10. The code activation device according to claim 7, wherein the sensor unit is a touch sensor unit or a beat sensor unit.

11. The code activation device according to claim 7, wherein the processing module comprises a transmitting unit for receiving the sensing signals and transmitting the activation signal to the back-end device.

12. The code activation device according to claim 7, wherein the processing module comprises a storage unit for storing the preset order.

13. A code activation device, used to transmit an activation signal to a back-end device, so as to activate the back-end device, wherein the code activation device comprises:
a sensing module, comprising sensor units, wherein the sensor units generate sensing signals according to a preset action of a trigger object; and
a processing module, connected to the sensing module, receiving the sensing signals, wherein each of the sensing signals corresponds to one of the sensor units, the processing module acquires a sensing order according to an order which the sensing signals are generated by the sensor units, generates a sensing beat according to interval periods between the sensing signals, and determines whether the sensing order and the sensing beat respectively match a preset order and a preset beat, wherein the processing module generates the activation signal when the sensing order and the sensing beat respectively match the preset order and the preset beat.

14. A code activation device, used to transmit an activation signal to a back-end device, so as to activate the back-end device, wherein the code activation device comprises:
a sensing module, comprising sensor units, the sensor units generate sensing signal sets according to a preset action of a trigger object, wherein the sensing signal set comprises sensing signals, and the time periods of the sensing signals included in the previously generated sensing signal set are earlier than those of the sensing signals included in the later generated sensing signal set; and
a processing module, connected to the sensing module, receiving the sensing signal sets including the sensing signals, wherein each of the sensing signal sets corresponds to one of the sensor units, the processing module acquires a sensing order according to an order which the sensing signal sets are generated by the sensor units, generates a sensing beat according to interval periods between the sensing signals included in each of the sensing signal sets, and determines whether the sensing order and the sensing beat respectively match a preset order and a preset beat, wherein the processing module generates the activation signal when the sensing order and the sensing beat respectively match the preset order and the preset beat.
